(19) United States
(12) Patent Application Publication
(10) Pub. No.: US 2022/0301165 A1
(43) Pub. Date: Sep. 22, 2022

(54) METHOD AND APPARATUS FOR EXTRACTING PHYSIOLOGIC INFORMATION FROM BIOMETRIC IMAGE

(71) Applicants: Optosurgical, LLC, Laurel, MD (US); INTHESMART Co., Ltd., Seoul (KR)

(72) Inventor: Jaepyeong CHA, Laurel, MD (US)

(73) Assignees: Optosurgical, LLC, Laurel, MD (US); INTHESMART Co., Ltd., Seoul (KR)

(21) Appl. No.: 17/696,801

(22) Filed: Mar. 16, 2022

Related U.S. Application Data
(60) Provisional application No. 63/163,936, filed on Mar. 22, 2021.

(51) Int. Cl. G06T 7/00; G06T 11/00; G06V 40/10; G06V 10/74; G06V 10/82

(52) U.S. Cl. CPC G06T 7/0014; G06T 11/00; G06V 40/10; G06V 10/74; G06V 10/82; G06T 2207/20081; G06T 2207/20084; G06T 2207/30104

(57) ABSTRACT

Provided is an apparatus for generating a biometric image comprising a processor; and a memory comprising one or more sequences of instructions which, when executed by the processor, causes steps to be performed comprising: receiving a first biometric image and a second biometric image paired with the first biometric image; and generating a first reconstruction biometric image from the first biometric image so as to match the first reconstruction biometric image and the second biometric image based on a machine learning model.

### A. TECHNICAL FIELD

The present disclosure relates to generating a biometric image using a machine learning model, more particularly, to an apparatus and method for extracting physiologic information of the biometric images and detecting anomalies of the biometric image using the machine learning model.

### B. DESCRIPTION OF THE RELATED ART

Tissue viability or ischemia detection is a crucial, but complicated task of clinical observation and diagnosis. Tissue perfusion is closely related to tissue viability in both cause and effect. Many clinical treatments require a tissue perfusion and viability check; especially, acute mesenteric ischemia surgery requires accurate identification of ischemic regions to determine surgical resection margins. However, this surgical decision is currently made subjectively by surgeons based on qualitative measurements of tissue colors, palpation, and pulsations.

Many new approaches have been tried to detect ischemic areas using pre-operative medical equipment such as MRI, CT, ultrasound. More recently, with the development of artificial intelligence learning models, many machine learning models are being introduced into the medical field.

Laser Speckle Contrast Imaging (LSCI) technique is an optical technology to measure tissue perfusion and vascularity in biomedicine. It analyzes the variation in the interference pattern of illuminated monochromatic laser light caused by the molecular motion of a target. Unlike RGB (Red-Green-Blue) or multispectral (hyperspectral) or polarimetric imaging devices, which collect surface information, LSCI collects a complete speckle pattern reflected from each observable point either in 2-dimensional or 3-dimensional space. The usefulness of this technology to detect flow information in preclinical and clinical applications has been well known.

However, since a device for performing the LSCI technique requires not only laser illumination which raises safety concerns, but also necessitates a high-resolution, high-frame-rate image sensor, dedicated laser sources and high-speed processing computers such as graphics processing units (GPUs), the use of LSCI, in the clinical environment, is still limited.

Recently, with the development of artificial intelligence learning models, many machine learning models are being introduced into the medical field. In order to detect, classify, and characterize biometric images using the machine learning models, the usual machine learning model is approached using supervised machine learning algorithms. For example, convolutional neural networks (CNN) are well specialized at learning pathology types relying on a large annotated training dataset. In this case not only many pathological images are needed, but moreover, the ground-truth segmentations of the pathologies and ischemia are required. However, it is hard to access large datasets for training in the medical and clinical domain. Especially, intraoperative annotations are very time-consuming, inefficient and almost impossible; thus, they are usually not available. In addition, since supervised learning methods are typically trained on a particular ischemic mechanism or pathology type, it is only able to detect specific types of ischemia or pathology. Accordingly, an approach using a different machine learning algorithm is needed to detect physiological or pathological information from the biometric images.

### SUMMARY OF THE DISCLOSURE

In one aspect of the present disclosure, an apparatus for generating a biometric image, comprises a processor; and a memory comprising one or more sequences of instructions which, when executed by the processor, causes steps to be performed comprising: receiving a first biometric image and a second biometric image paired with the first biometric image; and generating a first reconstruction biometric image from the first biometric image so as to match the first reconstruction biometric image and the second biometric image based on a machine learning model.

Desirably, the machine learning model may include a variational autoencoder having ladder networks.

Desirably, the machine learning model may be repeatedly trained to minimize a loss function for the variational autoencoder.

Desirably, the loss function may include a difference between pixel grayscale values of the first reconstructed biometric image and pixel grayscale values of the second biometric image.

In another aspect of the present disclosure, an apparatus for anomaly detection of a biometric image comprises a processor; and a memory comprising one or more sequences of instructions which, when executed by the processor, causes steps to be performed comprising: receiving a first biometric image and a ground truth biometric image; generating a reconstruction biometric image from the first biometric image based on a first machine learning model; training a second machine learning model using the ground truth biometric image; and predicting the presence or absence of an anomaly in the reconstructed image based on the pre-trained second machine learning model.

### BRIEF DESCRIPTION OF THE DRAWINGS

References will be made to embodiments of the disclosure, examples of which may be illustrated in the accompanying figures. These figures are intended to be illustrative, and not limiting. Although the disclosure is generally described in the context of these embodiments, it should be understood that it is not intended to limit the scope of the disclosure to these particular embodiments.

FIG. 1 is an exemplary diagram for explaining a learning method to generate a biometric image according to embodiments of the present disclosure.

FIG. 2 is a schematic diagram of an illustrative apparatus 100 for generating a biometric image according to embodiments of the present disclosure.

FIG. 3 illustrates a biometric image (e.g., biometric image) generated by an apparatus according to embodiments of the present disclosure.

FIG. 4 is a block diagram illustrating an apparatus for anomaly detection of a biometric image according to embodiments of the present disclosure.

FIG. 5 is an exemplary flowchart showing a method for generating an image according to embodiments of the present disclosure.

FIG. 6 is an exemplary flowchart showing an anomaly detection process of a biometric image according to embodiments of the present disclosure.

### DETAILED DESCRIPTION OF PREFERRED EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components that may be implemented in software, hardware, or a combination thereof.

It shall also be noted that the terms “coupled,” “connected,” “linked,” or “communicatively coupled” shall be understood to include direct connections, indirect connections through one or more intermediary devices, and wireless connections.

Furthermore, one skilled in the art shall recognize: (1) that certain steps may optionally be performed; (2) that steps may not be limited to the specific order set forth herein; and (3) that certain steps may be performed in different orders, including being done contemporaneously.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” or “in embodiments” in various places in the specification are not necessarily all referring to the same embodiment or embodiments.

In the following description, it shall also be noted that the terms “learning” shall be understood not to intend mental action such as human educational activity of referring to performing machine learning by a processing module such as a processor, a CPU, an application processor, micro-controller, and so on.

An “image” is defined as a reproduction or imitation of the form of a person or thing, or specific characteristics thereof, in digital form. An image can be, but is not limited to, a JPEG image, a PNG image, a GIF image, a TIFF image, or any other digital image format known in the art. “Image” is used interchangeably with “photograph”.

An “attribute(s)” is defined as a group of one or more descriptive characteristics of subjects that can discriminate for lesion. An attribute can be a numeric attribute.

A “pair image” is defined as an image obtained by different conditions when photographing an image of the same object. For example, if a color image is generated by photographing a tissue using visible light and a NIR image is generated by photographing the same tissue using light (e.g., near infrared ray) with a different wavelength band, the color image and the NIR image form a pair and both images are a pair image.

The terms “comprise/include” used throughout the description and the claims and modifications thereof are not intended to exclude other technical features, additions, components, or operations.

Unless the context clearly indicates otherwise, the singular forms “a,” “an,” and “the” are intended to include the plural forms as well. Also, when description related to a known configuration or function is deemed to render the present disclosure ambiguous, the corresponding description is omitted.

The embodiments described herein relate generally to diagnostic biomedical images. Although any type of biomedical image can be used, these embodiments will be illustrated in conjunction with bowel ischemia images. Furthermore, the methods disclosed herein can be used with a variety of imaging modalities including but not limited to: computed tomography (CT), magnetic resonance imaging (MRI), computed radiography, magnetic resonance, angioscopy, optical coherence tomography, color flow Doppler, cystoscopy, diaphanography, echocardiography, fluorescein angiography, laparoscopy, magnetic resonance angiography, positron emission tomography, single photon emission computed tomography, x-ray angiography, nuclear medicine, biomagnetic imaging, colposcopy, duplex Doppler, digital microscopy, endoscopy, fundoscopy, laser, surface scan, magnetic resonance spectroscopy, radio graphic imaging, thermography, and radio fluoroscopy.

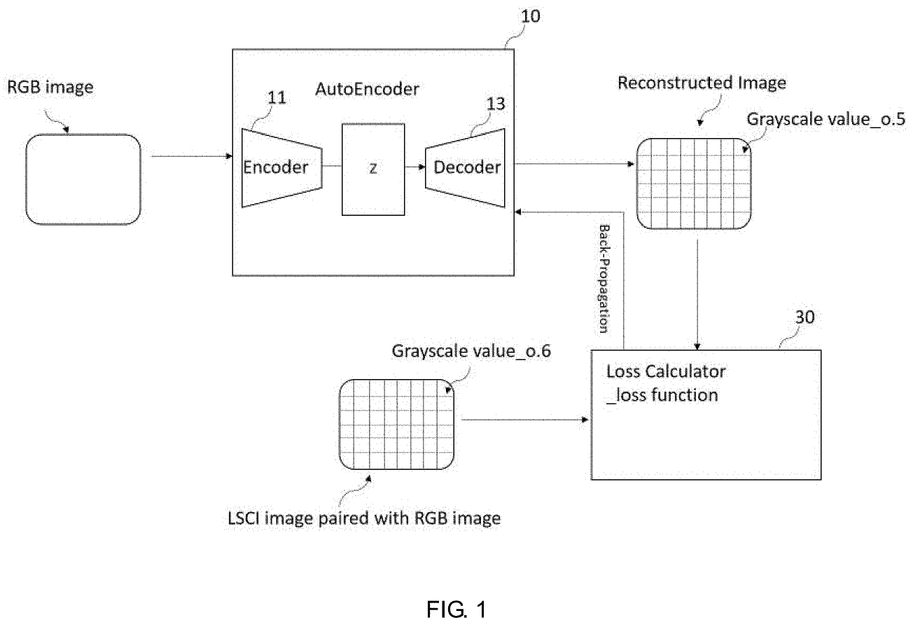

FIG. 1 is an exemplary diagram for explaining a learning method to generate a biometric image according to embodiments of the present disclosure.

As depicted, a machine learning model 10 may include a variational autoencoder. The variational autoencoder may include ladder networks. The autoencoder also may be a convolutional neural network (CNN) autoencoder or other types of autoencoders. The variational autoencoder may provide a probabilistic manner for describing an observation in latent space. Thus, the variational autoencoder can describe a probability distribution for each latent attribute. Each input image can be described in terms of latent attributes, such as using a probability distribution for each attribute.

The variational autoencoder may use an encoder 11 and a decoder 13 during workflow operation. If high-dimensional data is input to the encoder 11 of the autoencoder, the encoder 11 performs encoding to convert the high-dimensional data into a low-dimensional latent variable Z. In embodiments, the high-dimensional data may be a first image (an RGB image), and the first image may include, but be not limited to, a biometric image such as a bowel ischemia image or a thyroid image. In embodiments, the latent variable Z may generally be 2 to 10 dimensional data. The decoder 13 may output a reconstructed high-dimensional data by decoding the low-dimensional latent variable Z. In embodiments, the reconstructed high-dimensional data may be a first reconstructed image that is expressed as a grayscale.

The loss calculator 30 may calculate a difference between a comparison data stored in a memory (not shown) and the reconstructed high-dimensional data using a loss function, and the autoencoder may be repeatedly trained to minimize the loss function using a backpropagation algorithm. In embodiments, the comparison data may be a second image paired with the RGB image. The second image may be an image capable of detecting physiological or pathological information from a single modality image. For instance, the second image may include, but be not limited to, a near-infrared ray (NIR) image, a speckle pattern image (LSCI image) expressed through laser speckle contrast imaging. In embodiments, the loss function may use a mean squared error. In this case, the mean squared error may be the sum of squared differences between the pixel grayscale values of the first reconstructed image and the pixel grayscale values of the second image paired with the first image.

Thus, the learning method for generating a biometric image using the unsupervised machine learning algorithm of conditional variational autoencoder may be performed by a computing device 110 described below.

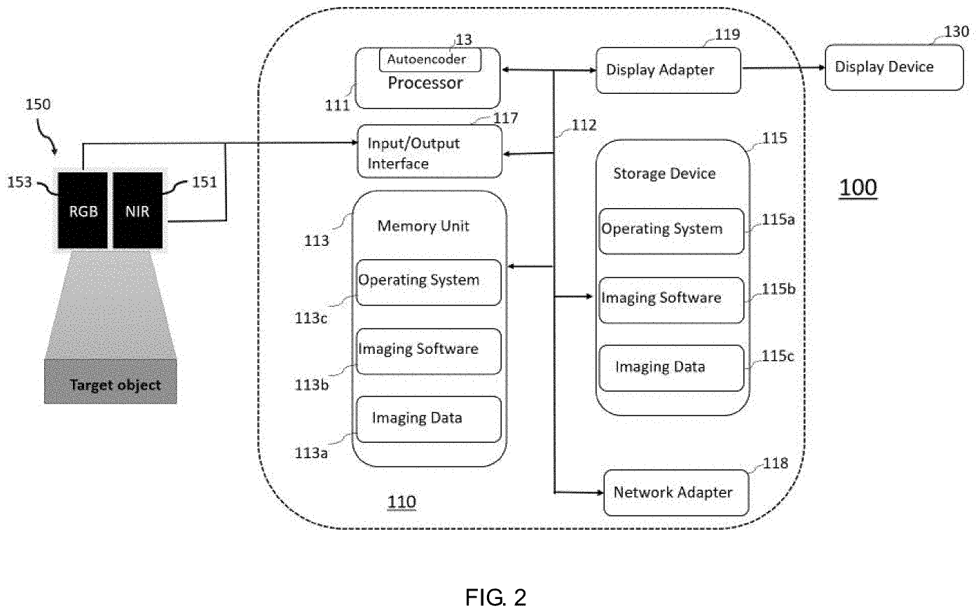

FIG. 2 is a schematic diagram of an illustrative apparatus 100 for generating a biometric image according to embodiments of the present disclosure.

As depicted, the apparatus 100 may include a computing device 110, a display device 130 and a camera 150. In embodiments, the computing device 110 may include, but is not limited thereto, one or more processor 111, a memory unit 113, a storage device 115, an input/output interface 117, a network adapter 118, a display adapter 119, and a system bus 112 connecting various system components to the memory unit 113. In embodiments, the apparatus 100 may further include communication mechanisms as well as the system bus 112 for transferring information. In embodiments, the communication mechanisms or the system bus 112 may interconnect the processor 111, a computer-readable medium, a short range communication module (e.g., a Bluetooth, a NFC), the network adapter 118 including a network interface or mobile communication module, the display device 130 (e.g., a CRT, a LCD, etc.), an input device (e.g., a keyboard, a keypad, a virtual keyboard, a mouse, a trackball, a stylus, a touch sensing means, etc.) and/or subsystems. In embodiments, the camera 150 may include image sensors 151, 153 that are capable of capturing images of a target tissue (e.g., a bowel ischemia, a thyroid). The images of the target tissue acquired by the camera 150 may be photoelectrically converted into an image signal by the image sensors 151, 153. The photographed images (e.g., a RGB image, a LSCI image) may be stored in the memory unit 113 or the storage device 115, or may be provided to the processor 111 through the input/output interface 117 and processed based on a machine learning model 13.

In embodiments, the processor 111 is, but is not limited to, a processing module, a Computer Processing Unit (CPU), an Application Processor (AP), a microcontroller, and/or a digital signal processor. In addition, the processor 111 may communicate with a hardware controller such as the display adapter 119 to display a user interface on the display device 130. In embodiments, the processor 111 may access the memory unit 113 and execute commands stored in the memory unit 113 or one or more sequences of instructions to control the operation of the apparatus 100. The commands or sequences of instructions may be read in the memory unit 113 from computer-readable medium or media such as a static storage or a disk drive, but is not limited thereto. In alternative embodiments, a hard-wired circuitry which is equipped with a hardware in combination with software commands may be used. The hard-wired circuitry can replace the soft commands. The instructions may be an arbitrary medium for providing the commands to the processor 111 and may be loaded into the memory unit 113.

In embodiments, the system bus 112 may represent one or more of several possible types of bus structures, including a memory bus or memory controller, a peripheral bus, an accelerated graphics port, and a processor or local bus using any of a variety of bus architectures. For instance, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. In embodiments, the system bus 112, and all buses specified in this description can also be implemented over a wired or wireless network connection.

A transmission media including wires of the system bus 112 may include at least one of coaxial cables, copper wires, and optical fibers. For instance, the transmission media may take a form of sound waves or light waves generated during radio wave communication or infrared data communication.

In embodiments, the apparatus 100 may transmit or receive the commands including messages, data, and one or more programs, i.e., a program code, through a network link or the network adapter 118. In embodiments, the network adapter 118 may include a separate or integrated antenna for enabling transmission and reception through the network link. The network adapter 118 may access a network and communicate with a remote computing device.

In embodiments, the network may be, but is not limited to, more than one of LAN, WLAN, PSTN, and cellular phone networks. The network adapter 118 may include at least one of a network interface and a mobile communication module for accessing the network. In embodiments, the mobile communication module may be accessed to a mobile communication network for each generation such as 2G to 5G mobile communication network.

In embodiments, on receiving a program code, the program code may be executed by the processor 111 and may be stored in a disk drive of the memory unit 113 or in a non-volatile memory of a different type from the disk drive for executing the program code.

In embodiments, the computing device 110 may include a variety of computer-readable medium or media. The computer-readable medium or media may be any available medium or media that is accessible by the computing device 100. For example, the computer-readable medium or media may include, but is not limited to, both volatile and non-volatile media, removable or non-removable media.

In embodiments, the memory unit 113 may store a driver, an application program, data, and a database for operating the apparatus 100 therein. In addition, the memory unit 113 may include a computer-readable medium in a form of a volatile memory such as a random access memory (RAM), a non-volatile memory such as a read only memory (ROM), and a flash memory. For instance, it may be, but is not limited to, a hard disk drive, a solid state drive, and/or an optical disk drive.

In embodiments, each of the memory unit 113 and the storage device 115 may be program modules such as the imaging software 113b, 115b and the operating systems 113c, 115c that can be immediately accessed so that a data such as the imaging data 113a, 115a is operated by the processor 111.

In embodiments, the machine learning model 13 may be installed into at least one of the processor 111, the memory unit 113 and the storage device 115. In embodiments, the processor 111 may generate a reconstructed image from the image (e.g., RGB image) stored in the memory unit 113 or the storage device 115, or provided from the camera 150 based on the trained machine learning model 13. In this case, the processor 111 may reconstruct the image using the machine learning model 13 trained by the learning method in described conjunction with FIG. 1. The reconstructed image generated by the processor 111 has substantially the same information as the information of the pair image (e.g., LSCI image) described in FIG. 1. The machine learning model 13 may be trained using unsupervised machine learning described in FIG. 1. The machine learning model 13 may include a variational autoencoder that includes ladder networks.

Thus, the apparatus 100 may generate the reconstructed image from the RGB image based on the learned model without collecting the LSCI image paired with the RGB image in order to accurately identify the tissue viability or ischemic region in the living tissue, and detect or extract tissue ischemia and pathological information from the reconstructed image in real time in the surgical environment.

If the apparatus 100 includes more than one computing device 110, then the different computing devices may be coupled to each other such that images, data, information, instructions, etc. can be sent between the computing devices. For example, one computing device may be coupled to additional computing device(s) by any suitable transmission media, which may include any suitable wired and/or wireless transmission media known in the art. Computing devices that implement at least one or more of the methods, functions, and/or operations described herein may comprise an application or applications operating on at least one computing device. The computing device may comprise one or more computers and one or more databases. The computing device may be a single device, a distributed device, a cloud-based computer, or a combination thereof.

It shall be noted that the present disclosure may be implemented in any instruction-execution/computing device or system capable of processing data, including, without limitation laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

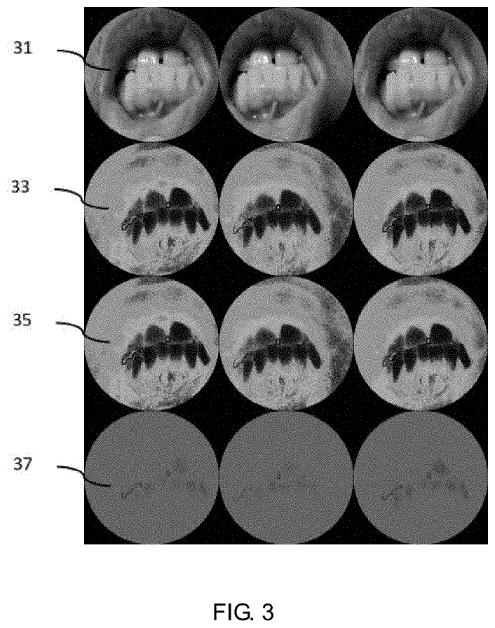

FIG. 3 illustrates images generated by an apparatus 100 according to embodiments of the present disclosure, wherein a first image 31 is a color (RGB) image obtained through a camera in a RGB mode of the apparatus, and is an input image input into a machine learning model, a second image 33 is a reconstructed LSCI image generated from the input color image based on the machine learning model, a third image 35 is a ground truth LSCI image (a LSCI image paired with the color image), which is obtained by image processing after photographing through a camera in a LSCI mode of the apparatus, and a fourth image 37 is an image obtained by image processing to subtract the third image data from the second image data using a processor 111 in order to detect a difference (e.g., pixel grayscale) between the second image and the third image.

As depicted in the fourth image 37, there is no difference between the reconstructed LSCI image 33 and the ground truth LSCI image 35. Thus, physiological or pathological information of living tissue can be detected only by the reconstructed LSCI image 33 without collecting the ground truth LSCI image 35.

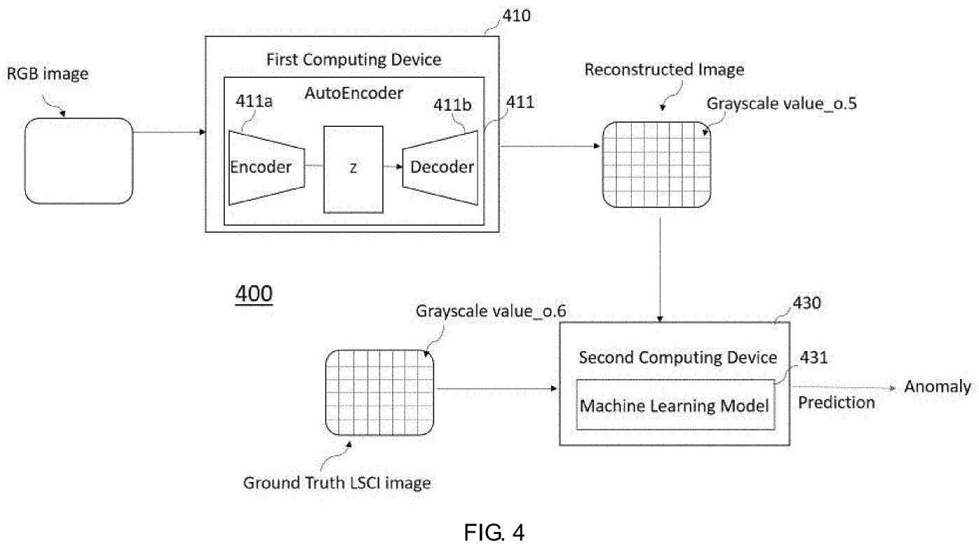

FIG. 4 is a block diagram illustrating an apparatus for anomaly detection of a biometric image according to embodiments of the present disclosure.

As depicted, the apparatus 400 may include a first computing device 410 including a first machine learning model and a second computing device 430 in which a second machine learning model is installed to detect image abnormalities. In embodiments, the anomaly may include all detectable objects, such as an abnormal behavior, an abnormal condition, and an abnormal object that can be distinguished from the detectable object. In embodiments, the first and second computing devices 410, 430 may be devices capable of computing function and may be, but are not limited to, a tablet computer, a desktop computer, a laptop computer, a server, or the like. Components (not shown) included into the first and second computing devices 410, 430 are similar to their counterparts of the computing device 110 in FIG. 2. The first machine learning model 411 installed to the first computing device 410 may be similar to the machine learning model 10 including the variational autoencoder described in FIG. 1. If the first image (e.g., RGB image) is input to the first computing device 410, a reconstructed image may be generated from the first image based on the pre-trained first machine learning model 411.

The second machine learning model 431 may be repeatedly trained using training image sets including attribute information in advance. In embodiments, the training image sets may be a second image (e.g., LSCI image) paired with the first image, as a ground truth image. In embodiments, the attribute information may include a pixel grayscale of an image. If the reconstructed image is input to the second computing device 430, the second computing device 430 may predict a presence of one or more anomalies in the reconstructed image based on the pre-trained second machine learning model 431. In this case, the second machine learning model 431 may determine whether there is an abnormality in the reconstructed image by calculating a difference between the pixel grayscale of the reconstructed image and the pixel grayscale of the ground truth image, or comparing the pixel grayscale of the reconstructed image and the pixel grayscale of the ground truth image. In embodiments, the first and second machine learning model 411, 431 may be unsupervised machine learning. The first and second machine learning model 411, 431 may be performed by a processor (not shown) of the first and second computing devices 410, 430.

As such, since the apparatus 400 according to embodiments of the present disclosure can train the unsupervised machine learning model using the limited normal data (e.g., ground truth image) and detect an abnormality in an image using the trained model, it can be used as a diagnostic aid in a medical environment.

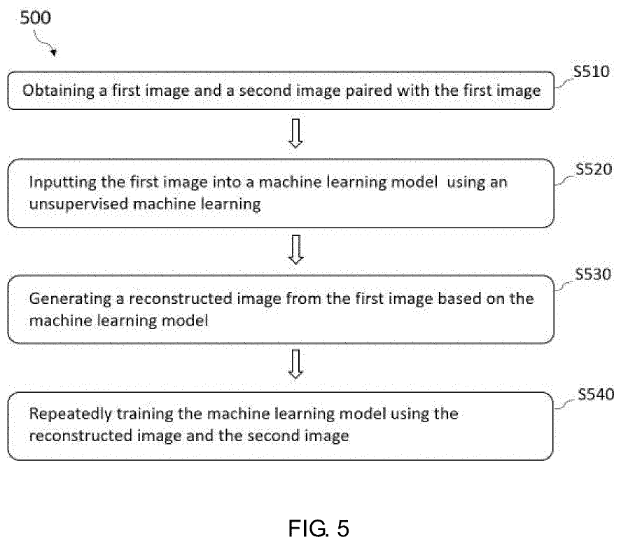

FIG. 5 is an exemplary flowchart showing a method for generating an image according to embodiments of the present disclosure. The method 500 may be performed by any suitable computing device. At step S510, a first image and a second image paired with the first image are obtained from a camera of an apparatus to make a training set. The first image may not include pixel labeling. In an example, RGB biometric images may be used as the training set. In embodiments, the RGB biometric image may include, but be not limited to, a bowel ischemia image, or a thyroid image. At step S520, if the first image is input into a machine learning model, the machine learning model using unsupervised machine learning is trained using the first image. The machine learning model may include a variational autoencoder that includes an encoder and a decoder. At step S530, the variational autoencoder may generate a reconstructed image from the first image. The variational autoencoder may include ladder networks. At step S540, the machine learning model may be repeatedly trained to minimize a loss function for the variational autoencoder using the reconstructed image and the second image. In this instance, the machine learning model may use a backpropagation algorithm. The second image may include, but be not limited to, a LSCI image, and/or a NIR image. The loss function may use, but be not limited to, a mean squared error.

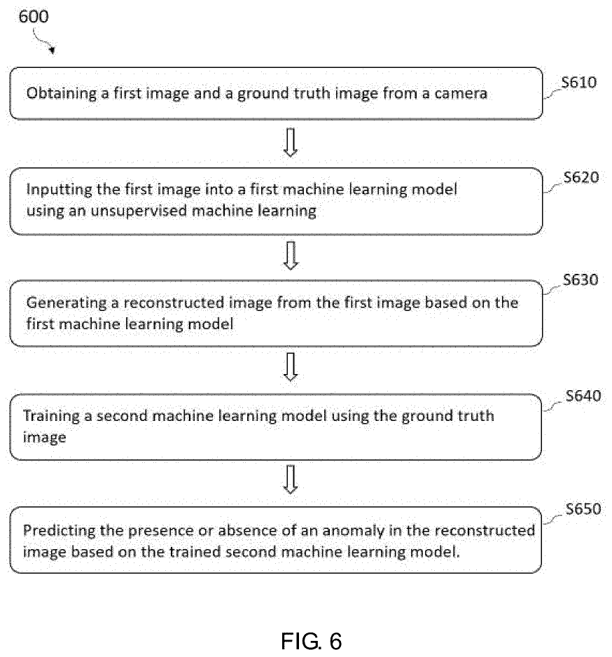

FIG. 6 is an exemplary flowchart showing an anomaly detection process of a biometric image according to embodiments of the present disclosure. The anomaly detection process 600 may be performed by any suitable computing device(s). At step S610, a first image and a ground truth image paired with the first image are obtained from a camera of an apparatus to make a training set. The first image may not include pixel labeling. In an example, RGB biometric images may be used as the training set. In embodiments, the RGB biometric image may include, but be not limited to, a bowel ischemia image, a thyroid image. At step S620, if the first image is input into a first machine learning mode, the first machine learning model using unsupervised machine learning is trained using the first image. The first machine learning model may include a variational autoencoder that includes an encoder and a decoder. At step S630, the variational autoencoder may generate a reconstructed image from the first image. The variational autoencoder may include ladder networks. At step S640, a second machine learning model may be trained using the ground truth image. The second machine learning model may use unsupervised machine learning or supervised machine learning. The ground truth image may include, but be not limited to, a LSCI image, and/or a NIR image. At step S650, if the reconstructed image is input into the second machine learning model, the trained second learning model may predict whether there is the presence or absence of an anomaly in the reconstructed image. In this case, the trained second learning model may compare a pixel grayscale of the reconstructed image and a pixel grayscale of the ground truth image.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store, or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. An apparatus for generating a biometric image, comprising:
a processor; and
a memory comprising one or more sequences of instructions which, when executed by the processor, causes steps to be performed comprising:
receiving a first biometric image and a second biometric image paired with the first biometric image; and
generating a first reconstruction biometric image from the first biometric image so as to match the first reconstruction biometric image and the second biometric image based on a machine learning model.

2. The apparatus of claim 1, wherein the machine learning model includes a variational autoencoder having ladder networks.

3. The apparatus of claim 1, wherein the machine learning model is repeatedly trained to minimize a loss function for the variational autoencoder.

4. The apparatus of claim 3, wherein the loss function includes a difference between pixel grayscale values of the first reconstruction biometric image and pixel grayscale values of the second biometric image.

5. An apparatus for anomaly detection of a biometric image, comprising:
a processor; and
a memory comprising one or more sequences of instructions which, when executed by the processor, causes steps to be performed comprising:
receiving a first biometric image and a ground truth biometric image;
generating a reconstruction biometric image from the first biometric image based on a first machine learning model;
training a second machine learning model using the ground truth biometric image; and
predicting the presence or absence of an anomaly in the reconstruction biometric image based on the pre-trained second machine learning model.

6. The apparatus of claim 5, wherein the first machine learning model and the second machine learning model is an unsupervised machine learning model.

7. The apparatus of claim 5, wherein the second machine learning model predicts an abnormality of the reconstruction biometric image by comparing a difference between pixel grayscale values of the reconstruction biometric image and pixel grayscale values of the ground truth biometric image.
